(19) United States
(12) Patent Application Publication
(10) Pub. No.: US 2015/0015141 A1
(43) Pub. Date: Jan. 15, 2015

(54) IGNITER-LESS POWER SUPPLY FOR XENON LAMPS IN AN ACCELERATED WEATHERING TEST APPARATUS

(71) Applicants: Gregory Mirsky, Buffalo Grove, IL (US); Michael Bandel, North Aurora, IL (US)

(72) Inventors: Gregory Mirsky, Buffalo Grove, IL (US); Michael Bandel, North Aurora, IL (US)

(21) Appl. No.: 14/505,118

(22) Filed: Oct. 2, 2014

Related U.S. Application Data
(63) Continuation-in-part of application No. 13/679,596, filed on Nov. 16, 2012.
(60) Provisional application No. 61/561,157, filed on Nov. 17, 2011.

(51) Int. Cl. H01J 61/54; H01J 61/16; H01J 61/56

(52) U.S. Cl. CPC H01J 61/54; H01J 61/56; H01J 61/16
USPC 315/45; 315/59

(57) ABSTRACT

A power supply for use in an accelerated weathering test apparatus can ignite the lamp without using a separate igniter and control both the xenon lamp radiated spectrum and its intensity in order to fully simulate the sun's daily cycle, improve the ultraviolet output, reduce the infrared radiation, and compensate for the xenon lamp aging.

### RELATED APPLICATIONS

The present utility patent application is a continuation-in-part of prior U.S. application Ser. No. 13/679,596, filed Nov. 16, 2012, which claims the benefit of and priority to U.S. Provisional Application No. 61/561,157, filed Nov. 17, 2011, each of the full disclosures of which are hereby incorporated by reference in their entirety.

### BACKGROUND

The present disclosure is related to power supplies for supplying power to a lamp in a weathering apparatus. The weathering device is used to simulate prolonged exposure to environmental elements. One such environmental element is sunlight. In order to accurately simulate exposure to sunlight, a weathering apparatus may use a high intensity lamp such as a xenon lamp. The present disclosure is related to a device to supply a xenon lamp with an irradiance spectrum shaped high-frequency sinusoidal current at minimum loss in order to control a radiated spectrum from such lamp and to using waveform shaping to manipulate the switching mode output voltage and current for obtaining a controllable xenon lamp radiated spectrum. As a result, the xenon lamp radiation spectrum is more precisely controlled during weathering tests in order to better simulate solar radiation, as well as improve xenon lamp output in the ultraviolet part of the radiated spectrum and reduce unwanted radiation in the infrared part of the spectrum. The system of the present disclosure further includes an ignition assisting reservoir of energy provided during pre-ignition phase of the lamp such that the lamp requires a less powerful igniter.

Conventional weathering apparatus and methods do not control any radiated spectrum or provide any mechanism for control of the xenon lamp radiated spectrum in the manner and method disclosed herein, and as a result are not as accurate. Additionally, existing xenon lamp power supply technology is based solely upon providing line frequency power ballasting, which is bulky, heavy, requires many features to provide limited control, and has no functionality to provide for electronic, universal power factor correction.

One known conventional device uses a pulsed DC mode of the xenon lamp operation, which is merely a modulation of the duty-cycle. Such a device is disadvantageous because it generates very high current abrupt surges that can destroy the cathode and reduce the life of the xenon lamp. Additionally, this conventional method does not accurately simulate the sun daily cycle.

In general, arc lighting AC output electronic power supplies for high intensity discharge lamps only regulated the current and/or power to the lamp. Additionally, limited lamp dimming was provided by allowing for control to reduce the magnitude of the lamp current. Typically, they were three stage power supplies consisting of a power factor corrector, a buck converter, and a low frequency AC inverter. They also required a separate igniter whose power was comparable to the whole power supply rated power to start the lamp. Irradiance control was non-existent, so as to not be considered.

Therefore, for devices that utilize gas discharge lamps and for devices that require the simulation of sunlight or some other irradiance spectrum, there exists a need for improved power supplies. Such needs include the ability to control the irradiance spectrum of the lamp to more accurately simulate the sun's daily cycle for use in devices such as accelerated weathering devices.

In addition, devices that utilize gas discharge lamps with known power supplies, require systems that can deliver a significant pulse of energy during ignition of the lamp. Also, the current control mechanisms of known power supplies can result in abrupt surges or spikes in current that can negatively impact the reliability and life of the gas discharge lamp. Therefore, improved power supplies are needed to provide ignition systems with lower power requirements such that operating costs of the device are reduced and the flexibility for choice of igniters is improved.

### SUMMARY

Generally, one aspect of the present disclosure may include an accelerated weathering apparatus that may include a power supply that can control both the xenon lamp radiated spectrum and its intensity in order to fully simulate the sun's daily cycle, improve the ultraviolet output, and reduce the infrared radiation. In one embodiment, a power supply may include a high frequency inverter for obtaining a controllable, waveform defined, output power being supplied to a xenon lamp. This provides the ability to develop a spectrum shaped lamp irradiance, a resonant circuit as a current source for a direct xenon lamp supply, and at the same time, a high-power, high voltage, xenon lamp backup for reliable arc initiation and setting at lower ignition voltage with a less powerful igniter. As a result, the embodiment may be more compact and less expensive due to use of high frequency power conversion technology and waveform manipulation, as well as have an ability to be computer monitored and controlled locally and/or remotely, even via the internet.

Another aspect of the present disclosure may include an accelerated weathering device that may include using a near resonant high frequency switching to create a lamp pre-ignition condition that can be advantageously configured to assist in lamp ignition. The size and energy requirements of known igniters may be reduced using aspects of the present disclosure as well as using other previously considered impractical methods of lamp ignition due to the back-up of high voltage and stored energy of some embodiments. The present disclosure allows for increased flexibility when choosing ignition type with potential for lower costs and increased operating life.

In another aspect of the present disclosure, a power supply is provided that includes a spectrum shaping component that is capable of providing a signal that controls the irradiance spectrum of a lamp.

In another aspect of the present disclosure, a power supply is provided that includes a pre-conditioning component that supplies a lamp with a high voltage and a reservoir of back-up energy to assist in the ignition and operation of the lamp.

In yet another aspect of the present disclosure, a weathering device is provided that includes a power supply that is able to control the irradiance spectrum of a lamp such that it simulates the sun's daily cycle.

### BRIEF DESCRIPTION OF THE DRAWINGS

FIG. 1 illustrates one embodiment of the power supply of the present disclosure.

FIG. 2 illustrates another embodiment of the power supply of the present disclosure.

FIG. 3 illustrates another embodiment of the power supply of the present disclosure.

FIG. 4 illustrates another embodiment of the power supply of the present disclosure.

FIG. 5 illustrates another embodiment of the power supply of the present disclosure.

FIG. 6 is a flowchart showing a method of operating the lamp and power supply of the present disclosure.

FIG. 7 illustrates one example voltage profile during pre-ignition using one of the power supply embodiments of the present disclosure.

FIG. 8 illustrates an example of the irradiance spectrum shaping output produced using one of the power supply embodiments of the present disclosure.

FIG. 9 is a side sectional view of an example weathering device including an example power supply of the present disclosure.

FIG. 10 illustrates one embodiment of the power supply output control of the present disclosure.

FIG. 11 illustrates another embodiment of the power supply output control of the present disclosure.

FIG. 12 illustrates an embodiment of a lamp of the present disclosure configured to function without an igniter.

FIG. 13 illustrates an embodiment of a lamp of the present disclosure with plates encircling the lamp.

FIG. 14 illustrates an embodiment of a lamp of the present disclosure with a conductive strip on the surface of the lamp.

FIG. 15 illustrates an embodiment of a lamp of the present disclosure with plates covering a portion of the surface of the lamp.

FIG. 16 illustrates a circuit diagram of an embodiment of a lamp and power supply of the present disclosure.

FIG. 17 illustrates the voltage applied to a lamp in accordance with the present disclosure.

### DETAILED DESCRIPTION

The following disclosure as a whole may be best understood by reference to the provided detailed description when read in conjunction with the accompanying drawings, drawing description, abstract, background, field of the disclosure, and associated headings. Identical reference numerals when found on different figures identify the same elements or a functionally equivalent element. The elements listed in the abstract are not referenced but nevertheless refer by association to the elements of the detailed description and associated disclosure.

The present disclosure is not limited to the particular details of the apparatus depicted, and other modifications and applications may be contemplated. Further changes may be made in the apparatus, device or methods without departing from the true spirit of the scope of the disclosure herein involved. It is intended, therefore, that the subject matter in this disclosure should be interpreted as illustrative, not in a limiting sense.

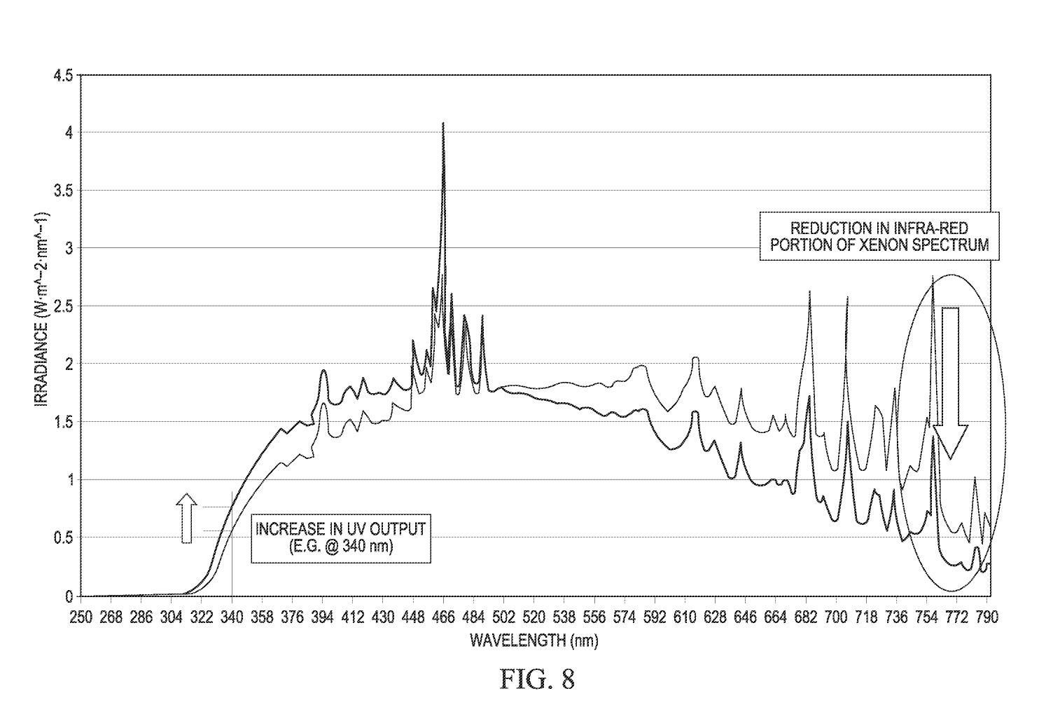

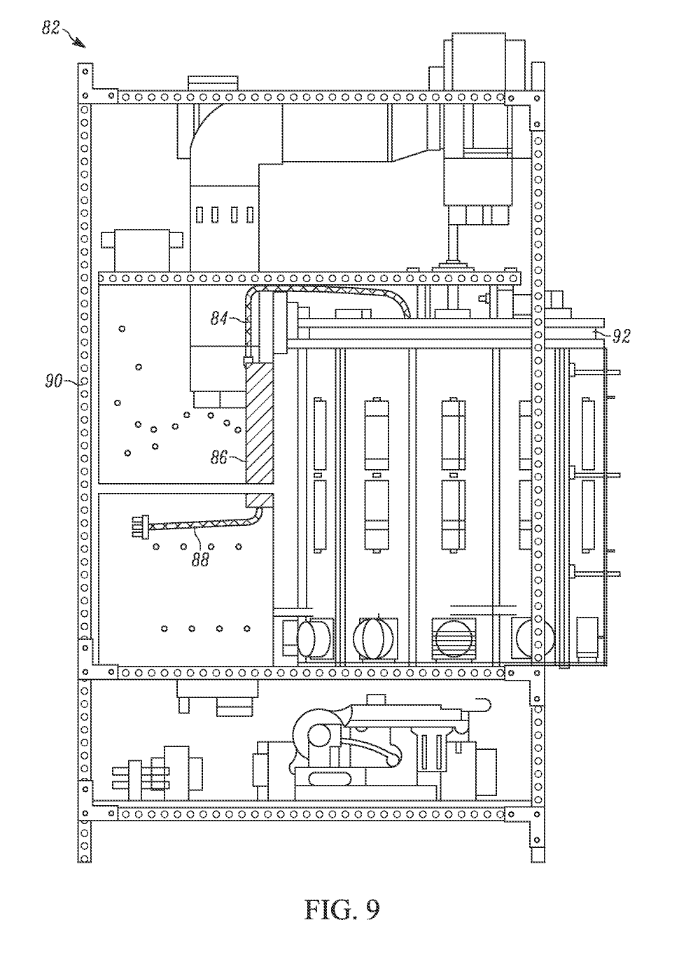

In one embodiment of the present disclosure, a weathering device is provided that includes a system for generating simulated sunlight as shown in FIG. 9. The system for generating simulated sunlight is located inside weathering device (82) within housing (90) and is operative to interact with test samples located on rack (92). The system for generating simulated sunlight can interact with many different weathering or testing apparatuses such as the embodiment shown in FIG. 8 or the weathering testing systems disclosed in U.S. Pat. Nos. 4,957,011, 5,226,318, or 5,503,032, the contents of which are incorporated herein by reference. The example system for generating simulated sunlight includes power supply (86) and lamp (10). In this example the lamp (10) is a xenon lamp oriented vertically within rack (92) of weathering device (82). In this example configuration, power supply (86) is located inside of weathering device (82) but outside rack (92) and the test chamber in order to be protected from the elements that are subjected to the test samples within the weathering device.

Lamp (10), in this example, is a xenon lamp. However, other gas discharge lamps can be used with the present disclosure including the embodiments of power supply (86) described herein. A xenon lamp is useful in the presently disclosed context for a xenon lamp's ability to simulate sunlight. Other lamps, however, may be used with the teachings of the present disclosure regarding the ignition of and irradiance spectrum shaping of other gas discharge lamps.

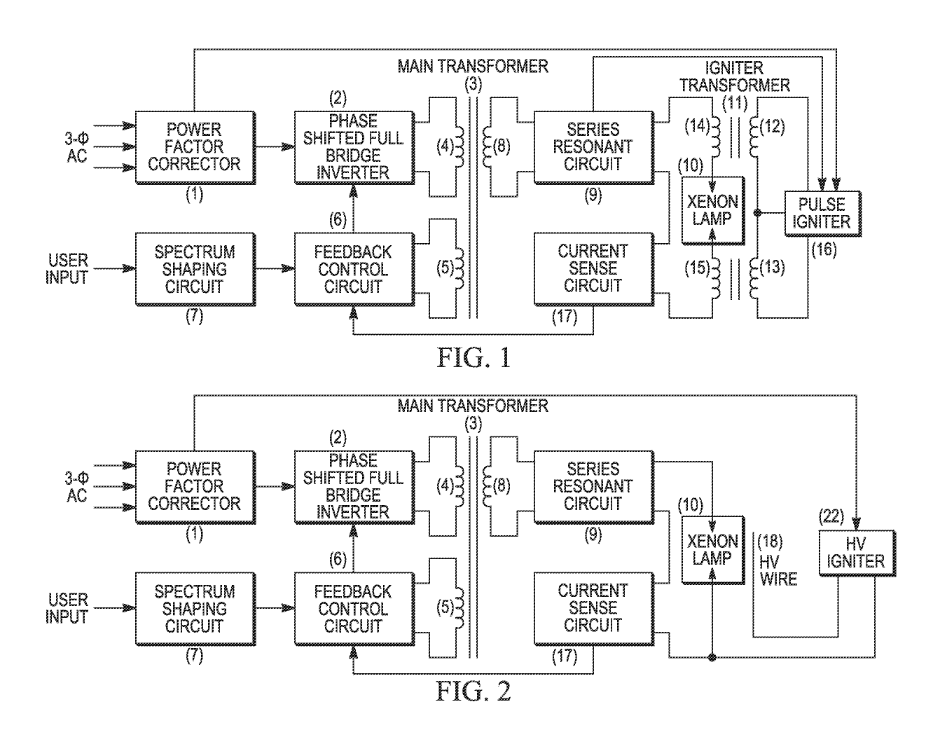

FIG. 1 shows an embodiment of power supply (86). Generally, the basic concept is a waveform shaped output, obtained through a pulse-width modulation of a high frequency, switching mode inverter power supply for AC Xenon powered lamps that allows for enriching the output current spectrum with low frequency, (with respect to the high frequency) components. In one embodiment, the device may be treated as a class D amplifier.

In the embodiment as shown in FIG. 1, the 3-phase AC mains drives a power factor corrector (1) that is capable of operating over a very wide input voltage range while maintaining a high power factor and low current total harmonic distortion. The power factor corrector (1) supplies output power to a phase-shifted full bridge inverter (2) in the form of DC voltage and current.

The phase-shifted full bridge inverter (2) receives power from the power factor corrector (1) and signal control from the feedback control circuit (6). It delivers power to the main transformer (3) via primary winding (4). The primary winding (4) of main transformer (3) loads the phase-shifted full-bridge inverter (2). A main secondary winding (8) transfers power to the series resonant circuit (9). An additional secondary winding (5) is a voltage feedback signal source to the feedback control circuit (6) to sense the status of power being transferred through the main transformer (3) and provide for necessary control.

The feedback control circuit (6) signals the phase-shifted full-bridge inverter (2), providing the necessary information for output control and regulation of the full system output power. The feedback control circuit (6) is also signaled by the spectrum shaping circuit (7). The feedback control circuit (6) senses voltage via the main transformer (3) secondary winding (5) and current sense circuit (17). The spectrum shaping circuit (7) signals a specific waveform construction to the feedback control circuit (6), and, it allows for user input control of the feedback loop current by providing for selection of, and where required, additional output spectrum shaping can occur.

The series resonant circuit (9) transfers power to the xenon lamp (10) during normal operation and provides current stabilization. It also initiates energy support for the pulse igniter (16) through the igniter transformer secondary windings (14) and (15) by creating a base voltage across the xenon lamp (10) to help start the lamp and provide sustaining energy once an ignition arc is established. Series resonant circuit (9) couples to xenon lamp (10) through igniter transformer (11), secondary windings (14) and (15) and current sense circuit (17). The primary windings (12) and (13) of igniter transformer (11) are driven by the pulse igniter (16), which is signaled by the unloaded series resonant circuit (9) during the pre-ignition and ignition phases of lamp start-up. The pulse igniter (16) pulses the igniter transformer (11) primary windings (12) and (13) to create a high enough voltage on the igniter transformer (11) secondary windings (14) and (15) to ignite the lamp by inducing an alternating current arc to flow between lamp cathodes. The pulse igniter (16) is fed from the power factor corrector (1) output for the best stability. Secondary windings (14) and (15) may be wound such that the starting points do not impose additional impedance on lamp (10) current development but produce high differential voltage across lamp (1) when pulse igniter (16) starts.

Current sense circuit (17) is a circuit configured to supply a feedback signal to feedback control circuit (6) that indicates the state of lamp (10) such that the power supply can manage or correct the power output through phase-shifted full bridge inverter (2). Current sense circuit (17) as shown in FIG. 1 in one embodiment is in series between the igniter transformer (11) secondary windings (14) and (15) and series resonant circuit (9).

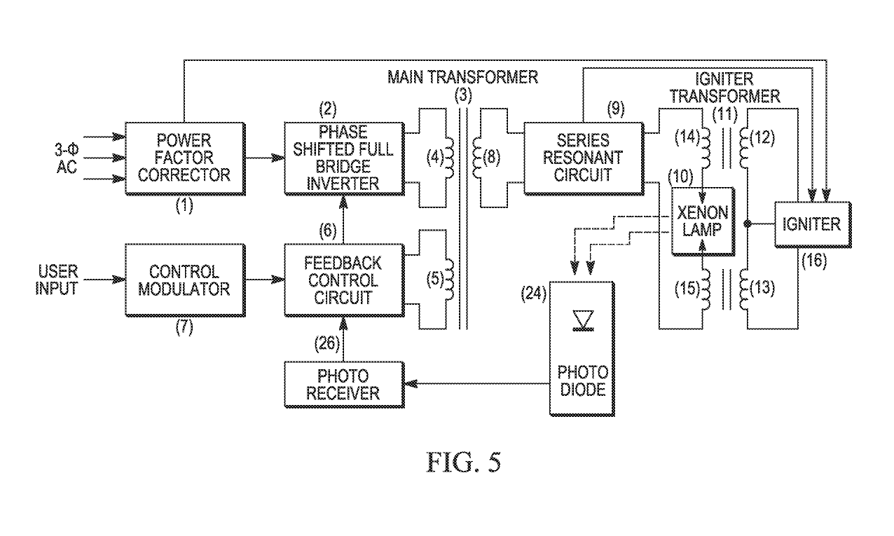

In another embodiment, as shown in FIG. 5, current sense circuit may include photo-sensor (24) connected to the photo-receiver (26), which in turn is connected to the feedback control circuit (6) and can assist in irradiance stabilization and aging compensation as well as assist in irradiance spectrum shaping. In addition to or in place of photo sensor (24) and photo receiver (26) a current sensor can be used assist to adjust, monitor, or control the voltage and the current.

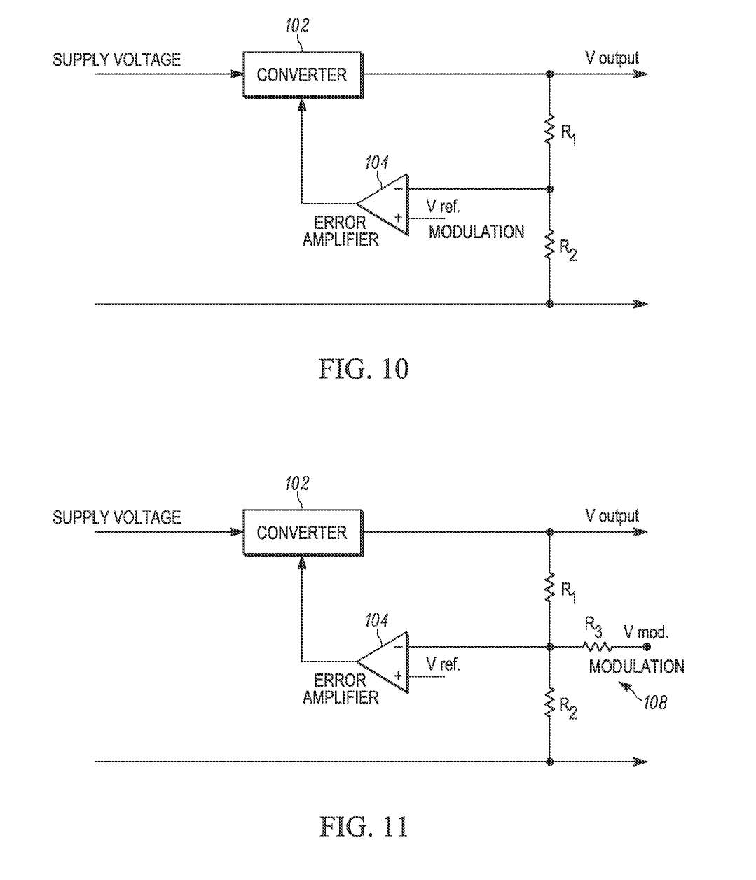

The modulation of current in power supply (86) can be accomplished via various methods to accomplish the irradiance spectrum shaping of the present disclosure. One embodiment of the power supply output control is shown in FIG. 10. In this embodiment, error amplifier (104) compares the output voltage/current to the reference signal and controls the converter (102) such that the output voltage/current is modified to take a predetermined shape such that lamp (10) produces a predetermined and reproducible irradiance spectrum.

FIG. 11 shows another embodiment of the power supply output control. In this embodiment, a modulated signal is introduced in the feedback loop through resistor (108). In this manner the reference signal at error amplifier (104) remains intact and the modulated signal can control the output current/voltage through converter (102). By varying the modulated signal, the output signal can be varied so that the current at lamp (10) can be much higher than the RMS value and at other times, much lower. Through this technique the irradiance spectrum output of lamp (10) can be varied to increase UV output and suppress infrared output.

FIG. 8 is a chart showing an example irradiance output of lamp (10) when used in conjunction with one example power supply of the present disclosure. As shown and referenced above, the portion of the irradiance spectrum in the UV portion of the spectrum is increased while the portion in the infrared portion of the spectrum is reduced.

In another aspect of the present disclosure, the power supply includes an ignition system with ignition assistance and an igniter element. As shown in FIG. 1, ignition assistance includes series resonant circuit (9). During pre-ignition, series resonant circuit (9) develops a reservoir of back-up energy that is available to lamp (10) such that a less powerful igniter is required for ignition of lamp (10).

In operation of one embodiment of the present disclosure as shown in FIG. 1, the xenon lamp (10) may be connected to its output to ignite and run as desired. At power on there is a pre-ignition phase when the xenon lamp (10) is still cold and does not present any load to the series resonant circuit (9). This is when the voltage across the xenon lamp (10) runs up to a magnitude of a few kilovolts, allowing pre-ionization streamers to form and begin to lower the very high impedance of the lamp. This is also when the series resonant circuit (9) builds and holds the energy of a few Joules for use in backing up the igniting process synchronized between the series resonant circuit (9), the igniter transformer (11), and pulse igniter (16) until the moment ignition occurs.

At ignition, the arc in the xenon lamp (10) establishes itself by means of a high voltage pulse from the pulse igniter (16) coupled through the igniter transformer (11) to the xenon lamp (10). Once an arc occurs, the lamp impedance is abruptly reduced and there is no longer a need for an ignition pulse from the pulse igniter (16). The xenon lamp (10) now shunts the energy of the series resonant circuit (9) through the igniter transformer (11) secondary windings (14) and (15) sustaining the ignition arc, reducing output voltage to that normally required for the lamp, and setting up constant lamp current.

The main factors in the determination of current magnitude through the xenon lamp (10) are the output voltage and frequency delivered by the secondary winding (8) of the main transformer (3), the inductor and capacitor elements, (not shown, but known to one of ordinary skill in the art) that determine the tuned frequency of the series resonant circuit (9), and inductance value of the inductor element in the series resonant circuit (9).

The spectrum shaping circuit (7) may be used to adjust irradiance spectrum of the xenon lamp (10) as determined by setting selection via user input. This is performed by using a waveform generator within spectrum shaping circuit (7) to act upon the feedback signaling through the feedback control circuit (6) and adjust or shape the xenon lamp (10) output current envelope. The lamp irradiance spectrum control is now governed by controlling the shape of the overall current envelope flowing through the xenon lamp (10). Therefore, by changing or trimming the shape of the signal waveform generated in the spectrum shaping circuit (7) one can adjust the xenon lamp (10) irradiance spectrum to a desired one or within a desired range. The irradiance spectrum variation during this adjustment can be monitored and verified by means of a spectroradiometer or spectrum analyzer of appropriate range.

Other embodiments of the power supply of the present disclosure include alternative configurations of the ignition system and ignition assistance and igniter element. In one example, shown in FIG. 2, the ignition system includes high voltage (HV) wire (18) which is driven from a low power, high voltage igniter. Here, the xenon lamp (10) is coupled through the current sense circuit (17) back to the series resonant circuit (9). High voltage igniter (22) is also referenced by connection to the bottom of the xenon lamp (10), receives signal from the power factor corrector (1), and is designed to generate a high voltage on HV wire (18) that is synchronized to occur at a point within the excitation envelope of the resonant circuit (9) during the transfer from pre-ignition to lamp ignition. In one example, HV wire (18) can be a thin nickel wire wound at a very large pitch around the lamp.

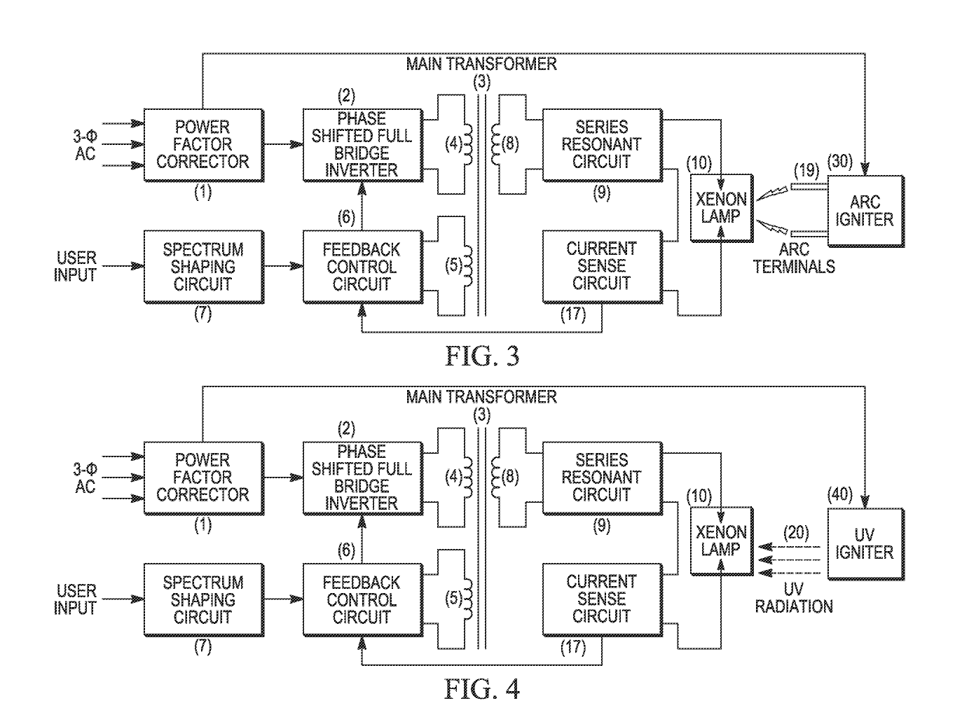

In another embodiment of the power supply of the present disclosure, shown in FIG. 3, the ignition system includes electrostatic arc terminals (19) driven by arc igniter (30). Here the power factor corrector (1) signals arc igniter (30) and the xenon lamp (10) current is strictly coupled through the current sense circuit (17) back to the series resonant circuit (9) without any lamp reference connection required for arc igniter (30). Again and during the pre-ignition build-up of the series resonant circuit (9) the ignition is initiated through electrostatic discharge with the lamp between the arc terminals (19).

In still another embodiment of the power supply of the present disclosure, shown in FIG. 4, the ignition system includes a UV radiation source (20) directed at the lamp. Here the power factor corrector (1) signals UV igniter (40) and the xenon lamp (10) is excited by UV radiation source (20) emitted by UV igniter (40). The mechanism here is to apply energy in the form of UV radiation to excite the xenon lamp (10) such that the few kilovolts expressed across the xenon lamp (10) by the series resonant circuit (9) during pre-ignition becomes sufficient to ignite the lamp. In one example, UV ignition is accomplished by a short-time pulse of UV radiation applied to the lamp (10) from an external source. Example sources of UV radiation include a UV laser, a compact UV-VIS fiber light source or other suitable UV sources.

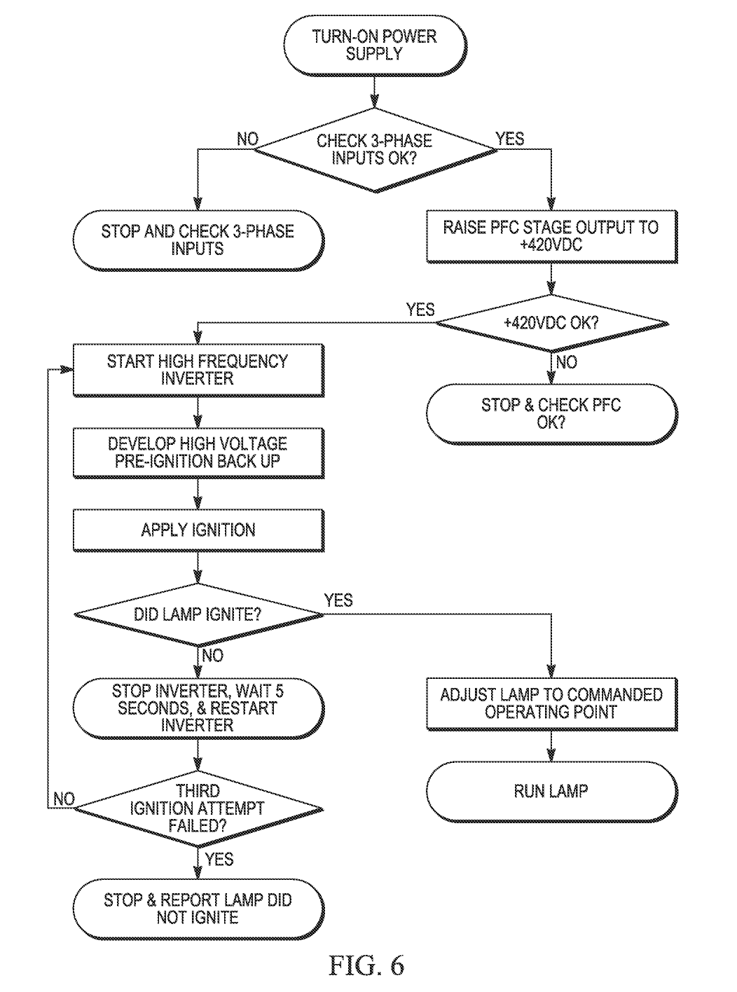

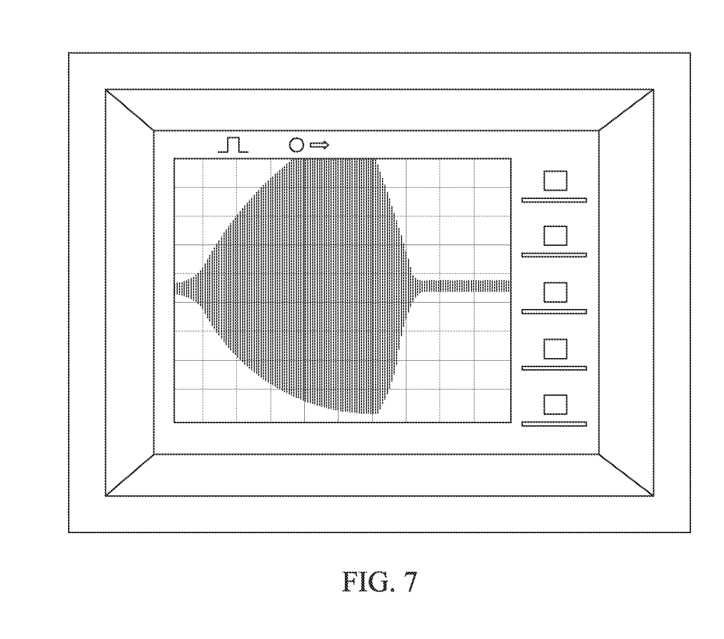

The reservoir of back-up energy provided by the power supply during pre-ignition is depicted in the image of FIG. 7. FIG. 7 shows one example of the voltage profile generated during the pre-ignition phase of operation. During such pre-ignition phase, the voltage across lamp (10) can run in the magnitude of a few kilovolts. Ignition of lamp (10) using any of the embodiments of the power supply can be operated using the flowchart shown in FIG. 6. Once ignition is achieved, lamp (10) can be operated to achieve the irradiance spectrum desired by the user.

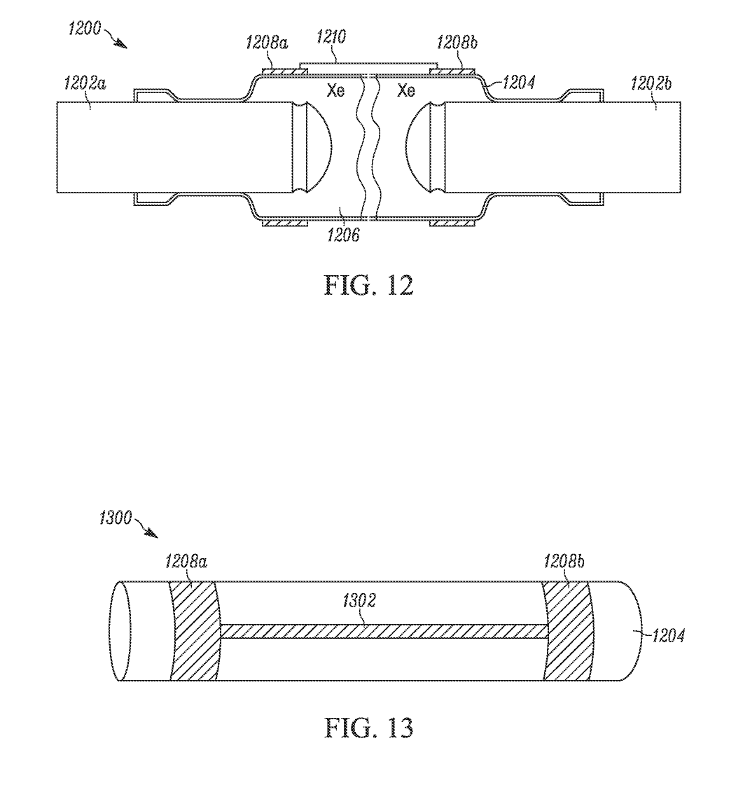

In embodiments of the present disclosure as shown in FIGS. 12-17, a lamp and power supply are configured to function without the use of a separate igniter but otherwise function in accordance with the teachings of the remainder of this disclosure. In embodiments, the lamp includes an ignition aid which enables the lamp to ignite at a lower voltage.

FIG. 12 depicts a cross section of a lamp in accordance with an embodiment of the present disclosure. As indicated by the broken lines, the central portion of the lamp has been omitted. As shown, the lamp 1200 may be a long arc lamp comprising two electrodes 1202a, 1202b surrounded by an envelope 1204. The electrodes 1202a, 1202b may be similar to the arc terminals (19) discussed above. The central portion of the envelop 1204 may be substantially cylindrical. In an embodiment, the lamp is a long arc xenon burner. In an embodiment, the envelope 1204 comprises an optically clear material such as glass or crystal. The envelope 1204 may be hermatically sealed around the electrodes 1202a, 1202b. The interior 1206 of the envelope 1204, including the space between the electrodes 1202a, 1202b, may be filled with a gas, such as xenon.

In an embodiment, the lamp 1200 includes an ignition aid comprising one or more plates. Plate 1208a is disposed on the exterior of the envelope 1204 proximate one electrode 1202a. As shown, the plate 1208a may comprise a ring which encircles the envelope 1204.

A second plate 1208b is located on the exterior surface of the envelope 1204 proximate the other electrode 1202b. The two plates 1208a, 1208b are electrically connected together, for example through a wire 1210 or a conductive strip running longitudinally along the exterior surface of the envelope 1204.

In an embodiment, the plates 1208a, 1208b and wire 1210 are applied to the envelope 1204 using metal deposition. Alternatively, the plates 1208a, 1208b and wire 1210 are attached using spring clips. In an embodiment, the plates 1208a, 1208b and wire 1210 are formed from a single conductive strip.

Alternatively, in an embodiment, the material comprising the envelope 1204 is selected so as to filter the light emitted by the lamp. For example, the material may block a portion of the light in the ultra-violet or infra-red spectrum so as to cause the light emitted from the lamp 1200 to have a desired spectrum.

FIG. 13 depicts an embodiment of a lamp 1300. As shown, the plates 1208a, 1208b completely encircle the envelope 1204. The plates are joined by a conductive strip 1302.

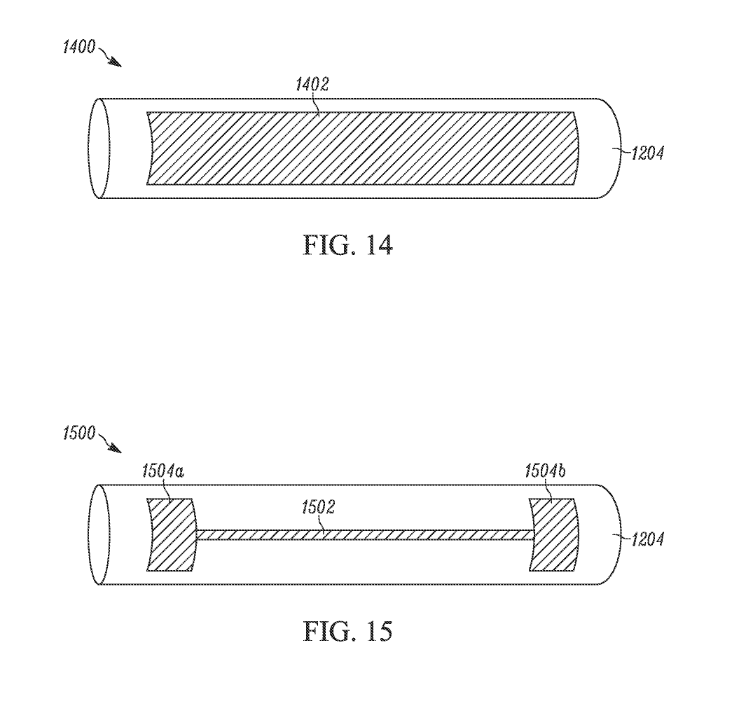

FIG. 14 depicts an embodiment of a lamp 1400 in which a single conductive strip 1402 is located on the exterior surface of the envelope 1204 such that each end is proximate one of the electrodes 1202a, 1202b. In an embodiment, multiple conductive strips are located on the envelop 1204 such that each strip is electrically isolated from every other strip. For example, two conductive strips may be arranged on opposite sides of the envelope 1204. Similarly, three or more conductive strips may be arranged equidistant from one another on the envelope 1204. Moreover, any number of conductive strips equally spaced about the perimeter of the envelope 1204 may also be so arranged.

FIG. 15 depicts an embodiment of a lamp 1500 in which the plates 1402a, 1402b extend less than halfway around the envelope 1204. The plates 1502a, 1502b are joined by a conductive strip 1504. The conductive strip may encircle less than 25% of the circumference of the envelope 1204. In an embodiment, plates 1502a, 1502b form one pair of plates. Additional pairs of plates may be located around the envelop 1204 such that each pair of plates is electrically isolated from every other pair of plates. Each pair of plates is joined by a conductive strip, similar to conductive strip 1504. In an embodiment, the pairs of plates are arranged equidistant from one another around the envelope 1204.

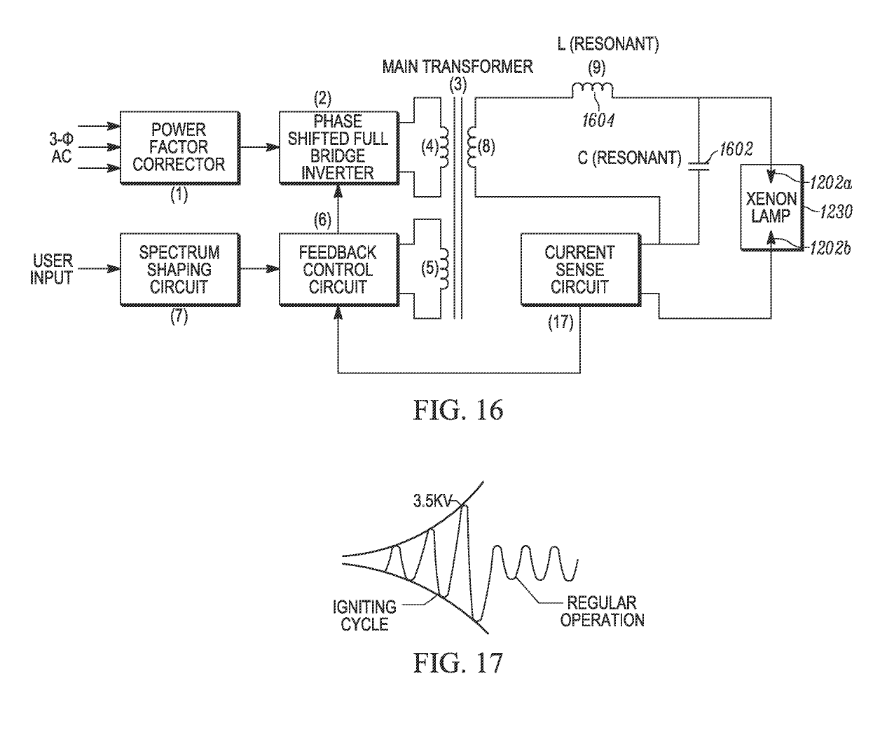

FIG. 16 depicts a circuit diagram wherein the lamp 1200 is connected to a power supply as described herein such that the lamp 1200 is in parallel with the resonant capacitor 1602 in the series resonant circuit (9) and is in series with the resonant inductor 1602. In other words, the first electrode 1202a is electrically connected to one plate of the resonant capacitor 1602, while the second electrode 1202b is electrically connected to the other plate of the resonant capacitor 1602. To ignite the lamp 1200, a high frequency alternating current is applied to the lamp 1200, at or near the resonance frequency of the resonant circuit (9). The plate 1208a (not shown) acts as a capacitor with the first electrode 1202a, while the second plate 1208b (not shown) acts as a capacitor with the second electrode 1202b. As the plates 1208a, 1208b are electrically connected, they act as two capacitors in series with the lamp. Once the voltage between one of the electrodes 1202a, 1202b and the corresponding plate 1208a, 1208b exceeds the breakdown voltage of the gas in the volume 1206 inside the envelope 1204, the gas breaks down through electrostatic discharge between the respective electrode 1202a, 1202b and plate 1208a, 1208b forming plasma. The voltage across the electrodes 1202a, 1202b quickly causes the plasma to propagate throughout the volume 1206, thereby igniting the lamp.

Significantly, as is clear to one of skill in the art, the breakdown voltage of the gas in the volume is dictated by Paschen's Law, which states that the breakdown voltage of a gas between two terminals depends upon the distance between the terminals and the pressure of the gas. Accordingly, as the distance between each electrode 1202a, 1202b and the corresponding plate 1208a, 1208b is significantly less than the distance between the electrodes 1202a, 1202b, the ignition voltage of the lamp 1200 is significantly reduced from that required for a standard gas discharge lamp.

FIG. 17 depicts the voltage applied across the electrodes 1202a, 1202b during ignition and at regular operation. As shown, the alternating voltage is gradually increased until the lamp ignites. In an embodiment, the plates 1202a, 1202b are configured such that the lamp 1200 ignites around 3.5 kV. After the lamp ignites, the voltage is reduced to that used during normal operation.

The preceding detailed description is merely some examples and embodiments of the present disclosure and that numerous changes to the disclosed embodiments can be made in accordance with the disclosure herein without departing from its spirit or scope. The preceding description, therefore, is not meant to limit the scope of the disclosure but to provide sufficient disclosure to one of ordinary skill in the art to practice the invention without undue burden.

What is claimed is:

1. A weathering device, comprising:
an arc lamp comprising:
a casing enclosing a first electrode and a second electrode, wherein one of the electrodes is disposed at each opposite end of the casing, a gap is defined between the electrodes and an interior surface of the casing, and the casing includes a gas disposed therein; and
a strip comprising an electrically conductive material coupled to an external surface of the casing such that a first end of the strip is located proximate to the first electrode, a second end of the strip is located proximate to the second electrode, and the strip extends longitudinally on the casing therebetween, wherein the first end of the strip is capacitively coupled to the first electrode and the second end of the strip is capacitively coupled to the second electrode when the electrodes are energized; and
a power supply electrically coupled to the electrodes and configured to energize the electrodes, the power supply including a series resonant circuit comprising an inductor in series with the electrodes and a capacitor in parallel with the electrodes, wherein the series resonant circuit has a resonance frequency and:
receives a signal with a voltage alternating at approximately the resonance frequency,
provides a base voltage across the electrodes,
produces a reservoir of back-up energy to assist in the ignition of the lamp, and
provides an ignition voltage between the first electrode and the strip that is sufficient to create an electrostatic discharge in the gap between the casing and the first electrode.

2. The weathering device of claim 1, wherein the gas is comprised of xenon.

3. The weathering device of claim 1, wherein the strip is comprised of a metal.

4. The weathering device of claim 3, wherein the strip is coupled to the external surface of the casing by metal deposition.

5. The weathering device of claim 1, wherein the strip is coupled to the external surface of the casing by at least one spring clip.

6. The weathering device of claim 1, wherein a portion of the casing extending from proximate the first electrode to proximate the second electrode is substantially cylindrical in shape with a substantially constant diameter that is less than the longitudinal length of the portion.

7. The weathering device of claim 1, wherein the power supply further includes a full-bridge inverter configured to receive an incoming signal with a unidirectional voltage and provide the signal to the series resonant circuit.

8. The weathering device of claim 7, wherein the power supply further includes a transformer with a primary winding electrically connected to the full-bridge inverter and a secondary winding electrically connected to the series resonant circuit and configured to transfer power from the full-bridge inverter to the series resonant circuit.

9. The weathering device of claim 1, wherein the strip is electrically isolated.

10. An electric discharge light source for a weathering device comprising:
a casing enclosing a first electrode, a second electrode and a gas, wherein the casing has a longitudinal axis, the electrodes are each disposed on the longitudinal axis at an opposite end of the casing, a central volume is defined between the electrodes and a gap is defined between each of the electrodes and an interior surface of the casing; and
an ignition aid comprising a first plate electrically connected to a second plate, wherein the plates are electrically conductive and connected to the casing such that when the electrodes are energized, the first plate is capacitively coupled to the first electrode and the second plate is capacitively coupled to the second electrode.

11. The electric discharge light source of claim 10, wherein the ignition aid further comprises an electrically conductive strip extending between the first plate and the second plate along the exterior surface of the casing parallel to the longitudinal axis.

12. The electric discharge light source of claim 10, wherein the gas is comprised of xenon.

13. The electric discharge light source of claim 10, wherein the plates are comprised of a metal.

14. The weathering device of claim 13, wherein the strip is coupled to the external surface of the casing by metal deposition.

15. The weathering device of claim 10, wherein the strip is coupled to the external surface of the casing by at least one spring clip.

16. The electric discharge light source of claim 10, wherein a portion of the casing proximate to the central volume is substantially cylindrical in shape and has a substantially constant diameter that is less than the longitudinal length of the portion.

17. The electric discharge light source of claim 16, wherein the plates do not encircle the casing.

18. The electric discharge light source of claim 10, wherein the electric discharge light source is configured to initiate an electrostatic discharge in the gap between the first electrode and the casing when a voltage is applied across the electrodes.

19. The electric discharge light source of claim 18, wherein the electric discharge light source is configured such that once the electrostatic discharge occurs, ionized gas proliferates throughout the central volume.

20. The electric discharge light source of claim 18, wherein the voltage is insufficient to directly initiate a second electrostatic discharge between the electrodes.

21. The electric discharge light source of claim 10, wherein the ignition aid is electrically isolated.

22. A method of operating a lamp for a weathering device, wherein the lamp comprises a casing enclosing a gas and a pair of electrodes placed such that a gap exists between each of the electrodes and the casing and an electrically conductive strip attached to the surface of the casing such that each end of the strip is proximate to one of the pair of electrodes and wherein the electrodes are electrically connected in parallel with a capacitor in a series resonant circuit with a resonance frequency, the method comprising:
applying a supply voltage alternating near the resonance frequency to the series resonant circuit;
applying a base voltage across the pair of electrodes using the series resonant circuit;
producing a reservoir of back-up energy in the series resonant circuit to assist in the ignition of the lamp;
creating an ignition voltage between the strip and one of the electrodes sufficient to cause an electrostatic discharge in the gap between the one of the electrodes and the casing and ionizing the gas;
igniting the lamp by propagating ionized gas between the pair of electrodes.

23. A method of igniting a lamp for use in a weathering device, wherein the lamp comprises a gas and a pair of electrodes separated by a volume enclosed by a casing and a conductive strip attached to the casing with ends each proximate to and separated by a gap from one of the pair of electrodes, the method comprising:
applying a voltage across the pair of electrodes, wherein the voltage between the pair of electrodes is insufficient to ionize the gas in the volume between the electrodes while the voltage between the strip and one of the pair of electrodes is sufficient to ionize the gas in the gap between the one electrode and the strip.
